(19) United States
(12) Patent Application Publication
(10) Pub. No.: US 2024/0043708 A1
(43) Pub. Date: Feb. 8, 2024

(54) INK COMPOSITION, DISPLAY DEVICE, AND METHOD OF MANUFACTURING THE SAME

(71) Applicant: Samsung Display Co., Ltd., Yongin-si (KR)

(72) Inventors: KYONGBIN JIN, Yongin-si (KR); Jiwon CHOI, Pyeongtaek- si (KR); DONGHO KIM, Yongin-si (KR); DONGWOON LEE, Yongin-si (KR)

(73) Assignee: Samsung Display Co., Ltd., Yongin-si (KR)

(21) Appl. No.: 18/359,359

(22) Filed: Jul. 26, 2023

(30) Foreign Application Priority Data
Jul. 27, 2022 (KR) 10-2022-0092966

(51) Int. Cl. C09D 11/107; C09D 11/037; B32B 7/12; B32B 33/00

(52) U.S. Cl. CPC C09D 11/107; C09D 11/037; B32B 7/12; B32B 33/00; B32B 2457/20

(57) ABSTRACT

An ink composition includes a base resin including an acrylic resin, a multifunctional curing agent having four or more functional groups, a pigment dispersed in the base resin, and a matting agent having a median particle size in a range of about 1.0 μm to about 2.0 μm and dispersed in the base resin. Accordingly, a single-layered printed layer formed from the ink composition may have improved light-shielding properties, surface hardness, durability, and adhesion strength.

### CROSS-REFERENCE TO RELATED APPLICATION(S)

This application claims priority to and benefits of Korean Patent Application No. 10-2022-0092966 under 35 U.S.C. § 119, filed on Jul. 27, 2022, in the Korean Intellectual Property Office (KIPO), the entire contents of which are incorporated herein by reference.

### BACKGROUND

### 1. Technical Field

The disclosure herein relates to an ink composition from which a printed layer is formed, a display device including a window with a printed layer, and a method of manufacturing the same.

### 2. Description of the Related Art

A display device provides information to users by displaying various images on a display screen. Specifically, a display device provides images generated by a display panel to users through a window.

A window may have a portion where images are transmitted and a portion where images are not transmitted. The portion where images are not transmitted may include an ink layer pattern, thereby preventing the internal component of a display device from being viewed by users and improving the aesthetics of a display device.

An ink layer pattern formed on a window needs to have the aesthetics while ensuring a sufficient adhesiveness to a component of a display device.

### SUMMARY

The disclosure provides an ink composition from which a printed layer may be formed which has excellent light-shielding properties even when provided as a single layer, and has excellent surface hardness, durability, and adhesion strength, and like.

The disclosure also provides a window and a display device which include a printed layer which has improved light-shielding properties, adhesion strength, and durability while having a small thickness.

The disclosure also provides a method of manufacturing a display device with an improved production yield.

An embodiment of the disclosure provides an ink composition that may include a base resin including an acrylic resin, a multifunctional curing agent having four or more functional groups, a pigment dispersed in the base resin, and a matting agent having a median particle size in a range of about 1.0 μm to about 2.0 μm and dispersed in the base resin.

In an embodiment, the ink composition may include a first ink composition including the base resin, the pigment, and the matting agent, and a second ink composition including the multifunctional curing agent.

In an embodiment, in case that a total content of the first ink composition is 100%, the first ink composition may include the base resin in a range of about 40% to about 45%, the pigment in a range of about 15% to about 20%, and the matting agent in a range of about 2% to about 4%.

In an embodiment, with respect to 100 parts by weight of the first ink composition, the second ink composition may be included in a range of about 25 parts by weight to about 35 parts by weight, and in case that a total content of the second ink composition is 100%, the second ink composition may include the multifunctional curing agent in a range of about 45% to about 55%.

In an embodiment, the first ink composition may further include at least one of an antifoaming agent and a leveling agent.

In an embodiment, the multifunctional curing agent may include a tetra-functional blocked isocyanate.

In an embodiment, a viscosity of the base resin may be in a range of about 250 poise to about 350 poise.

In an embodiment, the base resin may include a hydroxyl group, the multifunctional curing agent may include an isocyanate group, and a ratio of the hydroxyl group to the isocyanate group in the ink composition may be in a range of about 1:1.1 to about 1:1.5.

In an embodiment, the base resin may be a polymer resin having an average molecular weight in a range of about 20000 to about 40000.

In an embodiment of the disclosure, a display device may include a window, a display module disposed on the window, and a set module disposed on the display module. The window may include a window base, and a printed layer disposed on a first side of the window base and formed from an ink composition. The ink composition may include a base resin including an acrylic resin, a multifunctional curing agent having four or more functional groups, a pigment dispersed in the base resin, and a matting agent having a median particle size in a range of about 1.0 μm to about 2.0 μm and dispersed in the base resin.

In an embodiment, the display device may further include an adhesive layer disposed between the window and the display module and/or between the window and the set module. The printed layer may be attached to at least one of the display module and the set module by the adhesive layer.

In an embodiment, the printed layer may include a first printed layer including the matting agent and disposed adjacent to the display module and the set module, and a second printed layer disposed between the first printed layer and the window base and not including the matting agent.

In an embodiment, a thickness of the printed layer may be in a range of about 5 μm to about 7 μm.

In an embodiment, the printed layer may be a single layer formed from the ink composition.

In an embodiment of the disclosure, a method of manufacturing of a display device may include providing a window base having light-transmitting properties, and forming a printed layer by providing an ink composition on the window base. The ink composition may include a base resin including an acrylic resin, a multifunctional curing agent having four or more functional groups, a pigment dispersed in the base resin, and a matting agent having a median particle size in a range of about 1.0 μm to about 2.0 μm and dispersed in the base resin.

In an embodiment, the ink composition may include a first ink composition including the base resin, the pigment, and the matting agent, and a second ink composition including the multifunctional curing agent.

In an embodiment, with respect to 100 parts by weight of the first ink composition, the second ink composition may be included in a range of 25 parts by weight to about 35 parts by weight, and in case that the total content of the second ink composition is 100%, the second ink composition may include the multifunctional curing agent in a range of about 45% to about 55%.

In an embodiment, the printed layer may be a single layer formed from the ink composition.

In an embodiment, the method of manufacturing the device may further include providing a display module on the window base. The display module may be attached to at least a portion of an upper surface of the window base and an upper surface of the printed layer by an adhesive layer.

In an embodiment, the method of manufacturing the device may further include providing a set module on the window base. The set module may be attached to at least a portion of an upper surface of the printed layer by an adhesive layer.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain principles of the disclosure. In the drawings:

FIGS. 1 and 2 are perspective views illustrating a display device according to an embodiment of the disclosure;

FIG. 3 is a plan view of a window according to an embodiment of the disclosure;

FIG. 4 is a schematic cross-sectional view of a display module according to an embodiment of the disclosure;

FIG. 5 is a schematic cross-sectional view of a display device according to an embodiment of the disclosure;

FIG. 6 is an enlarged schematic cross-sectional view of a portion of a window according to an embodiment of the disclosure;

FIG. 7 is a flowchart illustrating a method of manufacturing a display device according to an embodiment of the disclosure;

FIGS. 8A to 8E are schematic cross-sectional views schematically illustrating operations of a method of manufacturing a display device according to an embodiment of the disclosure; and

FIGS. 9A to 9E are graphs showing the evaluation results of physical properties of a printed layer coating film formed from an ink composition according to an embodiment of the disclosure, and a printed layer coating film formed from an ink composition according to Comparative Examples and Reference Examples.

### DETAILED DESCRIPTION OF THE EMBODIMENTS

The disclosure may be implemented in various modifications and have various forms and specific embodiments are illustrated in the drawings and described in detail in the text. It is to be understood, however, that the disclosure is not intended to be limited to the particular forms disclosed, but on the contrary, is intended to cover all modifications, equivalents, and alternatives falling within the spirit and scope of the disclosure.

When an element, such as a layer, is referred to as being “on”, “connected to”, or “coupled to” another element or layer, it may be directly on, connected to, or coupled to the other element or layer or intervening elements or layers may be present. When, however, an element or layer is referred to as being “directly on”, “directly connected to”, or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

Like numbers or symbols refer to like elements throughout. Also, in the drawings, the thicknesses, ratios, and dimensions of the elements are exaggerated for effective description of the technical contents. In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

In the specification and the claims, the phrase “at least one of” is intended to include the meaning of “at least one selected from the group of” for the purpose of its meaning and interpretation. For example, “at least one of A and B” may be understood to mean “A, B, or A and B.”

Although the terms first, second, etc. may be used to describe various elements, these elements should not be limited by these terms. These terms are only used to distinguish one element from another element. For example, a first element may be referred to as a second element, and similarly, a second element may also be referred to as a first element without departing from the scope of the disclosure. The singular forms include the plural forms as well, unless the context clearly indicates otherwise.

Spatially relative terms, such as “beneath”, “below”, “under”, “lower”, “above”, “upper”, “over”, “higher”, “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below”, for example, can encompass both an orientation of above and below. Furthermore, the apparatus may be otherwise oriented (e.g., rotated 90 degrees or at other orientations), and, as such, the spatially relative descriptors used herein interpreted accordingly.

It will be understood that the term “includes” or “comprises”, when used in this specification, specifies the presence of stated features, integers, steps, operations, elements, components, or a combination the same, but does not preclude the presence or addition of one or more other features, integers, steps, operations, elements, components, or combinations the same.

Herein, it will be understood that “being directly disposed” means that there are no intervening layers, films, regions, plates or the like between the layers, films, regions, plates or the like and another element or layer. For example, “being directly disposed” may mean to be disposed between two layers or two members without using an additional member such as an adhesive member.

The terms “about” or “approximately” as used herein is inclusive of the stated value and means within an acceptable range of deviation for the particular value as determined by one of ordinary skill in the art, considering the measurement in question and the error associated with measurement of the particular quantity (for example, the limitations of the measurement system). For example, “about” may mean within one or more standard deviations, or within ±30%, 20%, 10%, 5% of the stated value.

The terms of “polymer unit” and “monomer” have the same meaning. In this specification, the term of the monomer is differentiated from the terms of an oligomer and a polymer, and is referred to as the compound having an average molecular weight of about 1,000 or less.

Unless otherwise defined, all terms (including technical and scientific terms) used herein have the same meaning as commonly understood by one of ordinary skills in the art to which the disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

Hereinafter, a cover window, a display device including the cover window, and a method of manufacturing the device according to an embodiment of the disclosure will be described with reference to the drawings.

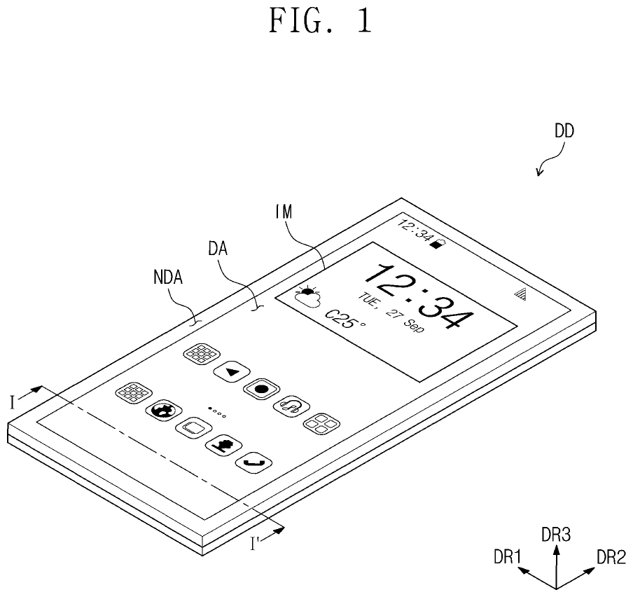

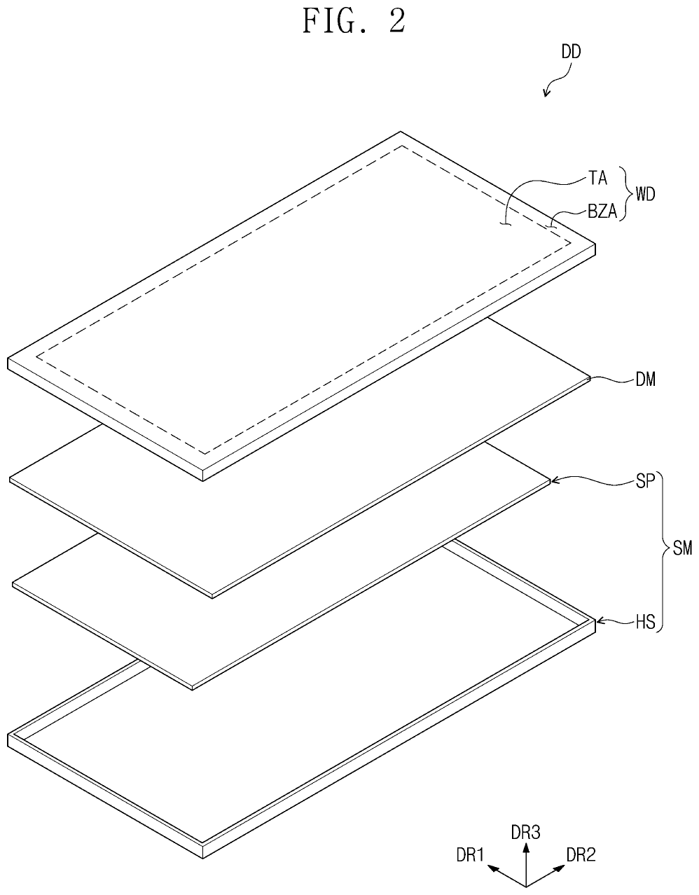

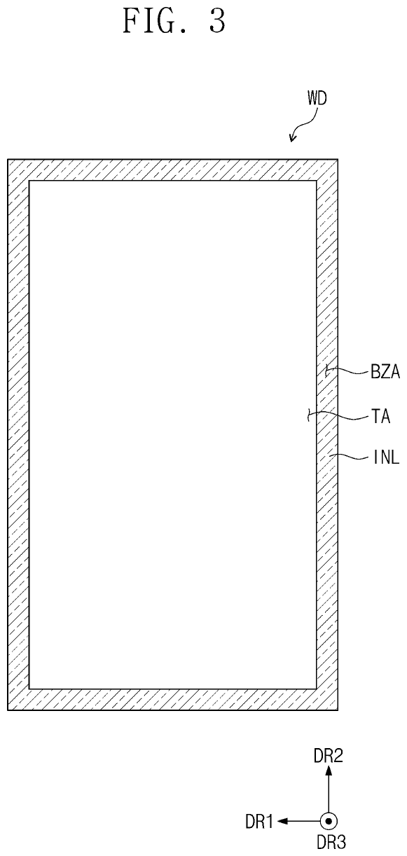

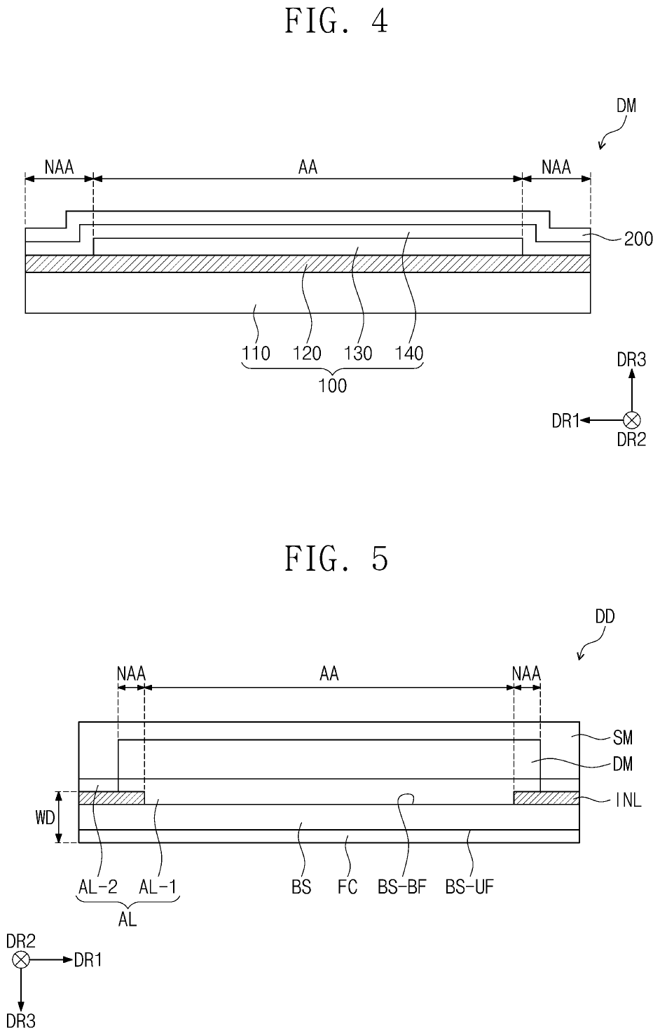

FIGS. 1 and 2 are perspective views illustrating a display device according to an embodiment. FIG. 3 is a plan view of a window according to an embodiment. FIG. 4 is a schematic cross-sectional view of a display module according to an embodiment.

FIG. 1 is a perspective view of an assembled display device DD, and FIG. 2 is an exploded perspective view of the display device DD.

With reference to FIGS. 1 and 2, the display device DD may be activated in response to an electrical signal. For example, the display device DD may be a personal digital assistant, a tablet PC, a vehicle navigation unit, a game console, or a wearable device, but the disclosure is not limited thereto. In FIGS. 1 and 2, the display device DD is illustrated as a mobile electronic apparatus.

The display device DD may display an image IM through a display area DA. The display area DA may include a plane defined by a first direction DR1 and a second direction DR2. However, the shape of the display area DA is not limited thereto, and for example, the display area DA may include a curved surface bent from at least one side of a plane defined by the first direction DR1 and the second direction DR2.

A non-display area NDA may be disposed adjacent to the display area DA. The non-display area NDA may surround the display area DA. Accordingly, the shape of the display area DA may be substantially defined by the non-display area NDA. However, the disclosure is not limited, and the non-display area NDA may be disposed adjacent to only one side of the display area DA, or may be disposed within the display area DA.

In FIG. 1 and the following drawings, a first direction DR1 to a third direction DR3 are illustrated. The directions indicated by the first to the third directions DR1, DR2, and DR3 described herein have relative concepts, and thus may be changed to other directions. In this specification, the first direction DR1 and the second direction DR2 may be orthogonal to each other, and the third direction DR3 may be a normal direction of a plane defined by the first direction DR1 and the second direction DR2.

The thickness direction of the display device DD may be parallel to the third direction DR3, which is a normal direction of a plane defined by the first direction DR1 and the second direction DR2. In this specification, a front surface (or an upper surface) and a rear surface (or a lower surface) of each member which constitutes the display device DD may be defined on the basis of the third direction DR3.

Referring to FIG. 2, the display device DD according to an embodiment may include a window WD, a display module DM, and a set module SM.

The window WD may be disposed on the display module DM and cover the entire front surface (upper surface) of the display module DM.

The window WD may have a shape corresponding to the shape of the display module DM. In the display device DD according to an embodiment, the window WD may include an optically transparent insulating material. The window WD may include a glass, a sapphire, or a polymer. For example, the window WD may include a tempered glass which has been chemically reinforced.

The window WD may be divided into a transmission area TA and a bezel area BZA. The transmission area TA may be a portion corresponding to the display area DA of the display device DD, and the bezel area BZA may be a portion corresponding to the non-display area NDA of the display device DD. The shape of the transmission area TA may be defined by the bezel area BZA. The bezel area BZA may be disposed adjacent to the transmission area TA and surround the transmission area TA. However, the disclosure is not limited to what is illustrated in FIG. 2, and the bezel area BZA may be disposed adjacent to only one side of the transmission area TA, or may be disposed within the transmission area TA.

Referring to FIG. 3, the window WD may include a printed layer INL. The printed layer INL may surround the transmission area TA. An area in which the printed layer INL is disposed may be defined as the bezel area BZA. The printed layer INL may prevent the internal component of the display device DD from being viewed from the outside, and may improve the aesthetics of the display device DD.

Referring to FIGS. 1 to 4, the display module DM may be disposed under the window WD. The display module DM may generate an image and detect an input applied from the outside. The display module DM according to an embodiment may include a display panel 100 and a sensor layer 200.

The display panel 100 may have a configuration for substantially generating an image. The display panel 100 may be a light-emitting display panel, for example, an organic light-emitting display panel, an inorganic light-emitting display panel, a micro LED display panel, or a nano LED display panel. The display panel 100 may also be referred to as a display layer.

The display panel 100 may include a base layer 110, a circuit layer 120, a light-emitting element layer 130, and an encapsulation layer 140.

The base layer 110 may be a member that provides a base surface on which the circuit layer 120 is disposed. The base layer 110 may be a rigid substrate or a flexible substrate capable of bending, folding, or rolling. The base layer 110 may be a glass substrate, a metal substrate, or a polymer substrate. However, the disclosure is not limited thereto, and the base layer 110 may be an inorganic layer, an organic layer, or a composite material layer.

The base layer 110 may have a multi-layered structure. For example, the base layer 110 may include a first synthetic resin layer, a multi or single-layered inorganic layer, and a second synthetic resin layer disposed on the multi or single-layered inorganic layer. Each of the first and second synthetic resin layers may include a polyimide-based resin, but the disclosure is not particularly limited thereto.

The circuit layer 120 may be disposed on the base layer 110. The circuit layer 120 may include an insulating layer, a semiconductor pattern, a conductive pattern, and a signal line. After an insulating layer, a semiconductor layer, and a conductive layer is formed on the base layer 110 through coating, depositing, and like, the insulating layer, the semiconductor layer, and the conductive layer may be selectively patterned by performing a photolithography process and an etching process multiple times.

The light-emitting element layer 130 may be disposed on the circuit layer 120. The light-emitting element layer 130 may include a light-emitting element. For example, the light-emitting element may include an organic light-emitting material, an inorganic light-emitting material, an organic-inorganic light-emitting material, quantum dots, quantum rods, a micro LED, or a nano LED.

The encapsulation layer 140 may be disposed on the light-emitting element layer 130. The encapsulation layer 140 may protect the light-emitting element layer 130 from foreign substances such as moisture, oxygen, and dust particles. The encapsulation layer 140 may include at least one inorganic layer, and may have a stacked structure of an inorganic layer/an organic layer/an inorganic layer.

The sensor layer 200 may be disposed on the display panel 100. The sensor layer 200 may detect an external input applied from the outside. The external input may be a user's input. The user's input may include various types of external inputs by a part of a user's body, light, heat, pen, pressure, or like.

The sensor layer 200 may be formed on the display panel 100 through a continuous process. The sensor layer 200 may be directly disposed on the display panel 100. Herein, “being directly disposed” may mean that there are no intervening components disposed between the sensor layer 200 and the display panel 100. For example, an adhesive member may not be disposed between the sensor layer 200 and the display panel 100.

An anti-reflection layer (not illustrated) may be disposed on the sensor layer 200. The anti-reflection layer may reduce the reflectance of external light incident from the outside of the display device DD. The anti-reflection layer may be formed on the sensor layer 200 through a continuous process. The anti-reflection layer may include color filters. The color filters may have an arrangement (predetermined or selectable). For example, the color filters may be arranged according to emission colors of pixels included in the display panel 100. The anti-reflection layer may further include a black matrix adjacent to the color filters.

In an embodiment of the disclosure, the sensor layer 200 may be omitted.

The display module DM may include an adhesive layer. The display module DM may be attached to the window WD by an adhesive layer. The adhesive layer may have transparency, for example, may be an optically clear adhesive film (OCA).

In the display module DM, an active area AA and a peripheral area NAA may be defined. The active area AA may be an area activated in response to an electrical signal. In the peripheral area NAA, a driving circuit, driving wiring, and the like for driving the active area AA may be disposed.

The active area AA may correspond to the display area DA of the display device DD illustrated in FIG. 1. The peripheral area NAA may correspond to the non-display area NDA of the display device DD illustrated in FIG. 1.

The peripheral area NAA may be disposed to surround the active area AA. However, the disclosure is not limited thereto. In an embodiment, the peripheral area NAA may be disposed adjacent to only one side of the active area AA, or may be disposed within the active area AA.

The set module SM may include a support layer SP and a housing HS. The support layer SP may have a single or multi-layered structure. The support layer SP may support the display module DM and the window WD. For example, the support layer SP may include at least one of a metal layer, a cushion layer, and a heat dissipation layer.

The housing HS may house the display module DM and the support layer SP, and may be assembled with the window WD. The housing HS may be obtained by assembling with multiple parts or may have a single body formed through an injection molding. The housing HS may include a glass, plastic, or metal.

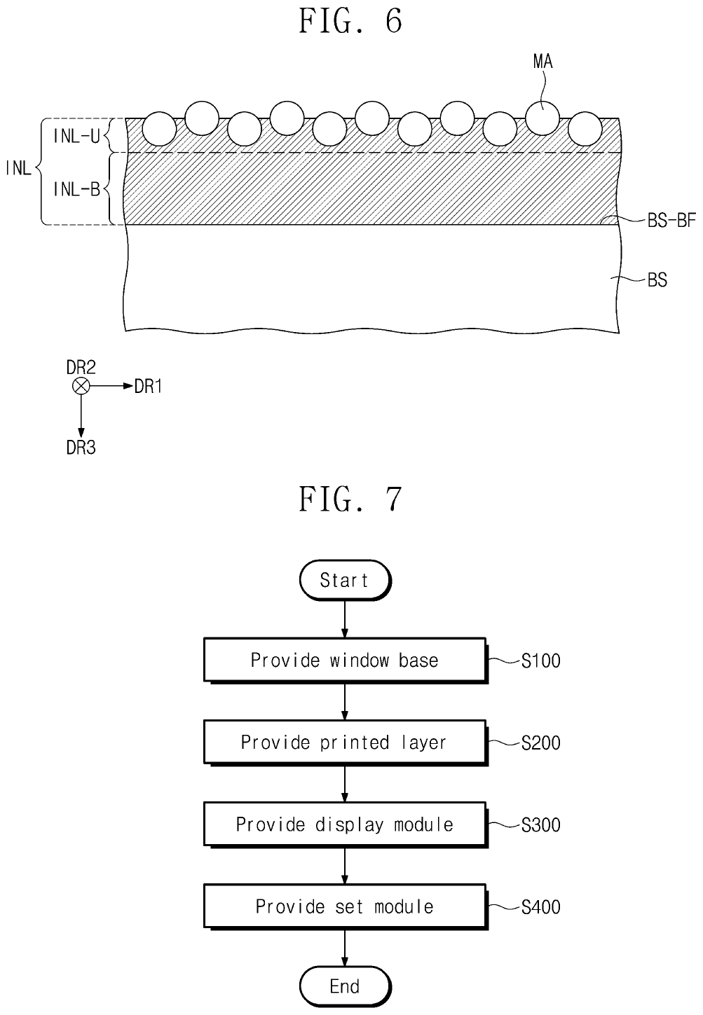

FIG. 5 is a schematic cross-sectional view of the display device according to an embodiment. FIG. 6 is an enlarged schematic cross-sectional view of a portion of the window according to an embodiment. FIG. 5 is a schematic cross-sectional view illustrating a portion taken along line I-I′ in FIG. 1 according to an embodiment.

In FIG. 5 and the following drawings, for convenience of description, the cross-sectional view is illustrated in which a front surface of the display device DD in FIG. 1 faces downward and a rear surface of the display device DD in FIG. 1 faces upward. In FIG. 5 and the following drawings, it will be explained that the display module DM is disposed on the window WD, and the set module SM is disposed on the display module DM. For example, in FIG. 5 and the following drawings, a direction opposite to the direction indicated by the third direction DR3 is described as an upper direction, and a direction indicated by the third direction DR3 is described as a lower direction. However, the upper or lower sides may be relative and may thus be changed to other directions.

Referring to FIG. 5, the display device DD according to an embodiment may include the window WD, the display module DM, and the set module SM. The display device DD according to an embodiment may further include an adhesive layer AL disposed between the window WD and the display module DM and between the window WD and the set module SM. The window WD according to an embodiment may include the window base BS and the printed layer INL.

The window base BS may be a transparent film through which light passes. For example, the window base BS may include at least one of a glass substrate, a sapphire substrate, and a plastic substrate.

The printed layer INL may be disposed on the window base BS. The printed layer INL may be disposed on a portion of the window base BS. The printed layer INL may be disposed on a first surface BS-BF of the window base BS. The printed layer INL may form a stepped portion on the window WD between a portion where the printed layer INL is disposed and a portion where the printed layer INL is not disposed. The stepped portion formed on the window WD may be covered by a first adhesive layer AL-1 to described below.

The printed layer INL may be disposed on the first surface BS-BF of the window base BS, and at least a portion of the printed layer INL may overlap the peripheral area NAA defined on the display module DM in a plan view. The printed layer INL may overlap the entire peripheral area NAA, and may not overlap the active area AA in a plan view.

The printed layer INL may be a single layer formed through a single process. For example, the printed layer INL may not include multiple layers distinguished by interfaces therebetween, and may be formed as a single layer having an integral shape. The printed layer INL may be formed by providing, through a single process, an ink composition to be described later. The printed layer INL may be directly formed on the first surface BS-BF of the window base BS, may contact the first surface BS-BF, and may contact the adhesive layer AL disposed on the printed layer INL. The printed layer INL may include a light-shielding material. For example, the printed layer INL may include carbon black as a light-shielding material and a carbon dispersant for dispersing carbon black. The printed layer INL may include a matting agent to have a specific surface roughness. The printed layer INL may include a material having a color (predetermined or selectable) to be a colored layer. For example, the printed layer INL may include materials having colors such as black, blue, red, and white.

The printed layer INL may have a thickness in a range of about 5 μm to about 7 μm in the third direction DR3. For example, the printed layer INL may have a thickness of about 6.2 μm. As described above, since the printed layer INL is provided as a single layer, the printed layer INL formed on the window WD, according to an embodiment, may have a small thickness of less than or equal to about 7 μm. In case that the printed layer INL has a thickness of less than about 5 μm, the light-shielding function of the printed layer INL may be reduced, so that a driving circuit or a driving wiring disposed in the peripheral area NAA may be viewed from the outside.

The display module DM may be disposed on the window WD. For example, the display module DM may be disposed on the first side BS-BF of the window base BS and a portion of the printed layer INL. For example, the active area AA of the display module DM may be disposed on the first surface BS-BF of the window base BS, and the peripheral area NAA of the display module DM may be disposed on a portion of the printed layer INL. The first adhesive layer AL-1 may be disposed between the display module DM and the window WD. The display module DM may be attached to the window WD by the first adhesive layer AL-1. Since the first adhesive layer AL-1 overlaps the active area AA in a plan view, the first adhesive layer AL-1 may include a transparent material. For example, the first adhesive layer AL-1 may be a transparent adhesive layer such as an optically clear adhesive film (OCA) or an optically clear resin (OCR).

The set module SM may be disposed on the window WD and the display module DM. For example, the set module SM may cover the display module DM and may be disposed on a portion of the printed layer INL of the window WD. A second adhesive layer AL-2 may be disposed between the set module SM and the printed layer INL. The set module SM may be attached to the window WD by the second adhesive layer AL-2. Since the second adhesive layer AL-2 does not overlap the active area AA, the second adhesive layer AL-2 may not include a transparent material, unlike the first adhesive layer AL-1. However, the disclosure is not limited thereto, and the second adhesive layer AL-2 may include a transparent material. For example, the second adhesive layer AL-2 may be a pressure sensitive adhesive film (PSA), an optically clear adhesive film (OCA), or an optically clear adhesive resin (OCR).

FIG. 5 illustrates that the first adhesive layer AL-1 through which the display module DM is attached to the window WD and the second adhesive layer AL-2 through which the set module SM is attached to the window WD are separate adhesive layers. However, the disclosure is not limited thereto, and the first adhesive layer AL-1 and the second adhesive layer AL-2 may be integral with each other. For example, each of the display module DM and the set module SM may be attached to the window WD by a same adhesive layer AL.

The window WD according to the disclosure may include a window functional layer FC disposed under the window base BS. The window functional layer FC may be disposed on a second surface BS-UF of the window base BS. The window functional layer FC may include at least one of an anti-fingerprint layer and a hard coating layer. The window functional layer FC may include a hard coating layer to protect the window WD from external impact. The window functional layer FC may include an anti-fingerprint layer to provide users with the convenience of using the window WD. However, the window functional layer FC is not limited thereto.

Referring to FIGS. 5 and 6 together, the printed layer INL may include a first printed layer INL-U and a second printed layer INL-B. The second printed layer INL-B may be disposed adjacent to the window base BS. The first printed layer INL-U may be disposed on the second printed layer INL-B adjacent to the display module DM and the set module SM. The first printed layer INL-U may be disposed adjacent to the adhesive layer AL. The second printed layer INL-B may be disposed between the first printed layer INL-U and the window base BS, and may contact the first surface BS-BF of the window base BS. In FIG. 6, the first printed layer INL-U and the second printed layer INL-B are separately illustrated for convenience of description. However, the first printed layer INL-U and the second printed layer INL-B may not be separated by an interface therebetween, and may be distinguishable by differences in components while including a same base material. For example, the first printed layer INL-U and the second printed layer INL-B may be integral with each other, and accordingly, the printed layer INL may be provided as a single layer.

The first printed layer INL-U and the second printed layer INL-B may be distinguished according to whether a matting agent MA is included. The first printed layer INL-U may include the matting agent MA, and the second printed layer INL-B may not include the matting agent MA. The matting agent MA may be particles which are included in the first printed layer INL-U defining the surface of the printed layer INL, achieve the matte surface of the printed layer INL, and lower external light reflection characteristics. Since the matting agent MA is disposed on the surface of the printed layer INL, the surface roughness of the printed layer INL may be increased. Accordingly, the adhesion strength between the printed layer INL and the adhesive layer AL may be improved.

The matting agent MA may include an organic material or an inorganic material. The matting agent MA may include, for example, silica powder. The matting agent MA may include synthetic polymer powder such as a polyethylene, a polypropylene, or a polyolefin. The matting agent MA may have a median particle size in a range of about 1.0 μm to about 2.0 μm. For example, the matting agent MA may have a median particle size of about 1.5 μm. Since the matting agent MA has a median particle size in the above-described range, the viscosity of an ink composition, from which the printed layer INL is formed, may be prevented from being excessively increased, and the printed layer INL may have strong adhesion strength to the adhesive layer AL even in case that the printed layer INL is provided as a single layer. Accordingly, the window WD which includes the printed layer INL having a single-layered structure may have improved durability and reliability. In the specification, “a median particle size” refers to the size of particles corresponds to about 50% in case that multiple particles are arranged in the order of size. For example, in case that the matting agent MA has a median particle size in a range of about 1.0 μm to about 2.0 μm, the size of particles of which corresponds to about 50% in the matting agent MA may be in a range of about 1.0 μm to about 2.0 μm in case that multiple particles are arranged in the order of size. The size distribution of particles of the matting agent MA may follow a normal distribution.

The window WD according to the disclosure may include the printed layer INL disposed on a portion of the window base BS, and the printed layer INL may not have a multi-layered structure and may have a single-layered structure. Accordingly, the manufacturing cost may be saved compared to the cost of the window including the multi-layered printed layer, and the thickness of the printed layer INL may be reduced, so that the window WD including the printed layer INL and the resultant display device DD may become thinner. Since the printed layer INL of an embodiment is formed from an ink composition according to an embodiment to be described below, the printed layer INL, even provided as a single layer, may have excellent light-shielding properties and have excellent surface hardness and durability as well as excellent adhesion strength to the adhesive layer AL.

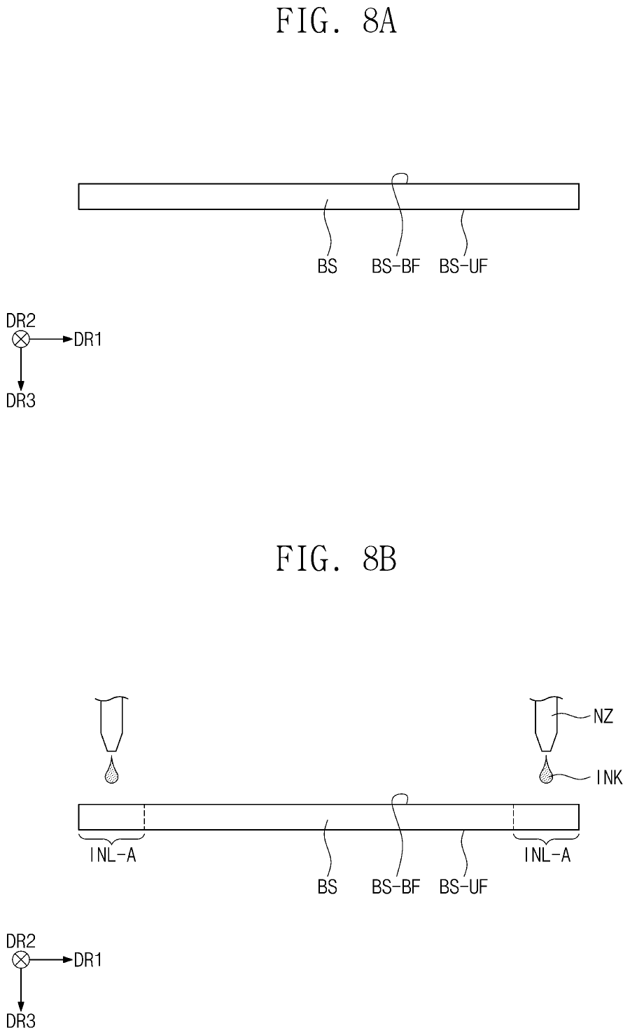

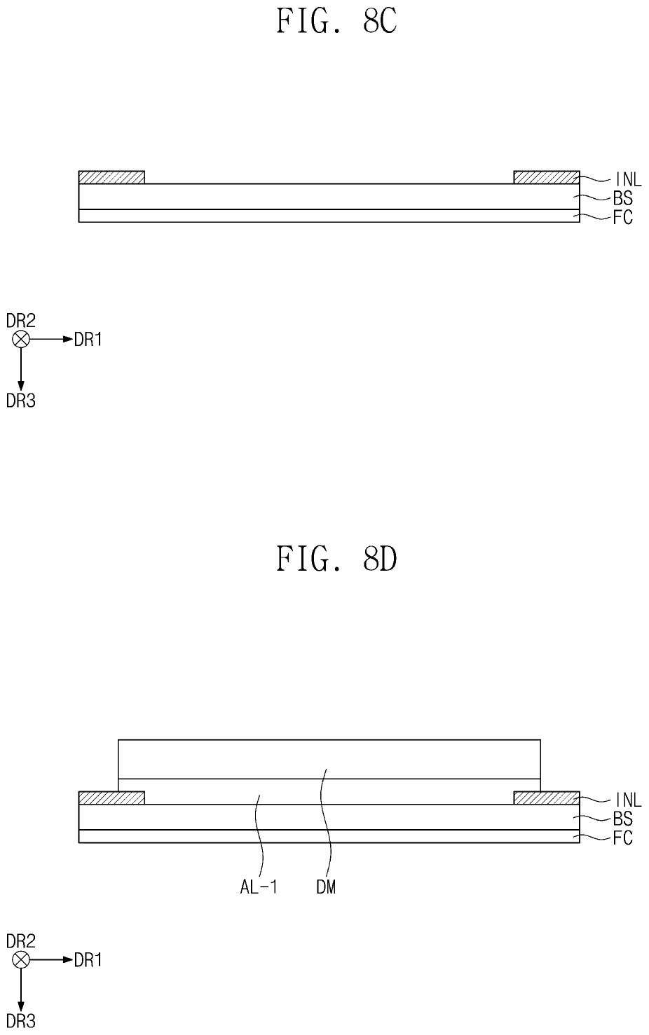

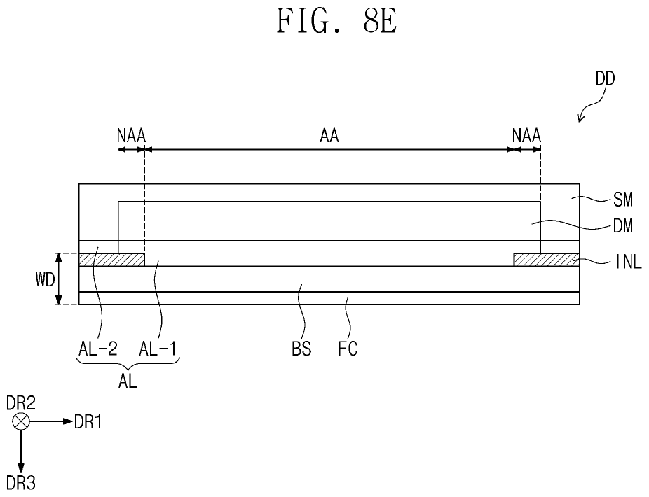

FIG. 7 is a flowchart illustrating a method of manufacturing a display device according to an embodiment. FIGS. 8A to 8E are schematic cross-sectional views schematically illustrating operations of a method of manufacturing a display device according to an embodiment. Hereinafter, components described with reference to FIGS. 1 to 6 are denoted by the same reference numerals or symbols, and a detailed description thereof will be omitted.

A method of manufacturing a display device according to an embodiment may include providing a window base (S100), providing a printed layer (S200), providing a display module (S300), and providing a set module (S400).

Referring to FIGS. 7 and 8A to 8C together, the providing of the window base (S100) and the providing of the printed layer (S200) may include providing an ink composition INK on a portion of the window base BS provided in a plate shape to form the printed layer INL.

The window base BS may include at least one of a glass substrate, a sapphire substrate, and a plastic substrate in a plate shape. For example, the window base BS may be a glass substrate. The window base BS may be a transparent substrate through which light passes.

A print area INL-A may be defined on the window base BS, and the ink composition INK may be applied on the print area INL-A through a nozzle NZ. Using a mask, the ink composition INK may be provided in the print area INL-A, and may not be provided in other areas except the print area INL-A. The ink composition INK provided in the print area INL-A may be dried for a time (predetermined or selectable) to form the printed layer INL.

The ink composition INK, according to an embodiment of the disclosure may be used for forming the printed layer INL of a window. For example, the ink composition INK, according to an embodiment of the disclosure may be printed on the first side BS-BF of the window base BS and define the bezel area BZA (see FIG. 3) of a window.

The ink composition INK, according to an embodiment of the disclosure may include a base resin, a multifunctional curing agent, a pigment, and a matting agent. The ink composition INK according to an embodiment may include, in addition to the base resin, the multifunctional curing agent, the pigment, and the matting agent, an additive including at least one of an antifoaming agent and a leveling agent.

The base resin may include an acrylic resin. In an ink composition of the disclosure, the acrylic resin may be a polymer compound derived from a monomer including an acrylate or methacrylate functional group in a molecular structure. The acrylic resin may control the crosslinking density in an ink composition to ensure the strength, durability, and surface hardness of a coating film in case that the ink composition is cured, and also control adhesion strength to other materials. The acrylic resin may include, for example, at least one of an alkyl (meth) acrylate, a hydroxyalkyl acrylate, a polyethylene glycol alkyl ether methacrylate, a perfluorinated alkyl (meth) acrylate, and a silicone (meth) acrylate. In the specification, “(meth) acrylate” may include acrylate and methacrylate. The base resin including the acrylic resin may include a hydroxyl group in a molecular structure. An acrylic resin may be a polymer resin having an average molecular weight in a range of about 20000 to about 40000. The acrylic resin may have a viscosity in a range of about 250 poise to about 350 poise. For example, the acrylic resin may have a viscosity of about 300 poise.

The multifunctional curing agent may link the acrylic resin to enable the ink composition to have a high crosslinking density, thereby improving the strength, durability, and barrier properties of a coating film. The multifunctional curing agent may be a curing agent having four or more functional groups in a molecular structure. According to an embodiment, the multifunctional curing agent may include a blocked isocyanate oligomer. For example, the multifunctional curing agent may be a tetra-functional blocked isocyanate oligomer. According to an embodiment, the multifunctional curing agent may be a blocked isocyanate oligomer having 5 or more functional groups. The multifunctional curing agent may be a compound having 4 or more isocyanate groups in a molecular structure.

For example, the multifunctional curing agent may have a structure represented by the Chemical Formula a.

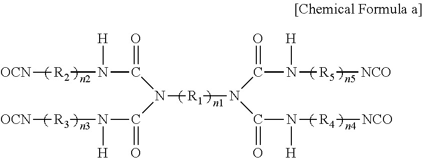

In Chemical Formula a, R₁ to R₅ may each independently be a substituted or unsubstituted alkyl group having 1 to 12 carbon atoms, or a substituted or unsubstituted aryl group having 6 to 30 carbon atoms. For example, R₁ to R₅ may each be an unsubstituted methyl group.

n1 to n5 may each be an integer of 1 to 10. In case that n1 to n5 are each an integer of 2 or more, R₁ to R₅, which are each provided in plural, may be same as or different from each other. For example, n1 to n5 may each be 6.

The ink composition INK according to an embodiment may be formed by mixing a first ink composition including a base resin, a pigment, and a matting agent and a second ink composition including a multifunctional curing agent. The providing of the ink composition INK may further include, before the providing of the ink composition INK to the window base BS, mixing the first ink composition including a base resin, a pigment, and a matting agent and the second ink composition including a multifunctional curing agent. The first ink composition including a base resin and the second ink composition including a multifunctional curing agent may be provided separately, and mixed before provided on the window base BS, and the resultant mixture may be provided in the form of the ink composition INK. Since the ink composition INK according to an embodiment is provided in a state in which the first ink composition including a base resin and the second ink composition including a multifunctional curing agent are separately provided, it may be possible to prevent a crosslink from occurring before the ink composition INK is provided to the window base BS.

In the mixing of the first ink composition and the second ink composition, a hydroxyl group of the acrylic resin may react with an isocyanate group of the multifunctional curing agent to form a crosslink. For example, a hydroxyl group positioned at the end of the acrylic resin may react with an isocyanate group positioned at the end of the multifunctional curing agent to form multiple crosslinks. In an ink composition according to the disclosure, the multifunctional curing agent may have multiple functional groups of 4 or more, and thus, the acrylic resin and the multifunctional curing agent may have a network structure connected by multiple crosslinks.

The ink composition according to an embodiment of the disclosure may include a pigment such as carbon black. The pigment may be included in the first ink composition described above. The carbon black may be included as a pigment in the ink composition. The ink composition according to the disclosure may include carbon black and thus be used for forming a printed layer which has a light-shielding property for shielding light. In the ink composition according to an embodiment of the disclosure, one or more pigments described above or mixtures thereof, besides the carbon black, may be used as the pigment.

The ink composition, according to an embodiment of the disclosure may include a matting agent described above. The matting agent may be included in the first ink composition described above. The matting agent may be provided as spherical particles having a diameter (predetermined or selectable), and may be particles with which the matte surface of a printed layer formed from the ink composition according to an embodiment is achieved and the external light reflection is lowered. Since the ink composition according to an embodiment includes a matting agent, a printed layer formed from the ink composition may have improved surface roughness. As described above, the matting agent may include an organic material or an inorganic material. For example, the matting agent may include silica powder. The matting agent may include synthetic polymer powder such as a polyethylene, a polypropylene, or a polyolefin. The matting agent may have a median particle size in a range of about 1.0 μm to about 2.0 μm. For example, the matting agent may have a median particle size of about 1.5 μm.

The ink composition according to an embodiment of the disclosure may further include an additive including at least one of an antifoaming agent and a leveling agent. The additive may be included in the first ink composition described above. The ink composition according to an embodiment may further include, as an additive, a dispersant, a barium sulfate filler, or the like.

The antifoaming agent may burst air bubbles generated in the ink composition to prevent defects in the exterior during formation of a coating film. The leveling agent may adjust the flow of ink to prevent paint defects such as craters in case that a coating film such as a printed layer is formed from an ink composition. The dispersant may uniformly disperse a pigment such as carbon black in ink. The barium sulfate filler may be an inert substance for adjusting the viscosity of an ink composition to prevent cracks during formation of a coating film.

In the first ink composition including the base resin, the pigment, and the matting agent, in case that the total content of the first ink composition is 100%, the first ink composition may include a base resin in a range of about 40% to about 45%, a pigment in a range of about 15% to about 20%, and a matting agent in a range of about 2% to about 4%. In the first ink composition including an additive such as an antifoaming agent and a leveling agent, in case that the total content of the first ink composition is 100%, an additive may be included in a range of about 2% to about 4%. The first ink composition may further include a residual solvent in addition to the base resin, the pigment, the matting agent, and the additive described above. For example, the solvent may be water.

In the ink composition according to an embodiment, in case that the content of the first ink composition is about 100 parts by weight, the second ink composition may be included in a range of about 25 parts by weight to about 35 parts by weight. In case that the total content of the second ink composition is 100%, the second ink composition may include the multifunctional curing agent in a range of about 45% to about 55%. The second ink composition may further include a residual solvent in addition to the multifunctional curing agent. For example, the solvent may be water.

As described above, the base resin included in the first ink composition may include a hydroxyl group as a functional group by including an acrylic resin, and the multifunctional curing agent included in the second ink composition may include an isocyanate as a functional group. With respect to the total ink composition, the hydroxyl group and the isocyanate group may be included at a ratio (predetermined or selectable). In the ink composition according to an embodiment, the ratio between the hydroxyl group and the isocyanate group may be in a range of about 1:1.1 to about 1:1.5. For example, the ratio between the hydroxyl group and the isocyanate group in the ink composition may be about 1:1.3. In the ink composition, the ratio between the hydroxyl group and the isocyanate group may be provided in the above-described range, and thus excellent durability and adhesion strength may be obtained in case that a printed layer, which is provided as a single layer from the ink composition, is formed.

The ink composition according to an embodiment of the disclosure may include a base resin, a multifunctional curing agent, a pigment, and a matting agent and the base resin, the multifunctional curing agent, the pigment, and the matting agent may be included respectively in the ink composition in the above-described content ranges. The multifunctional curing agent may have four or more functional groups, and the median particle size of the matting agent may be provided in the above-described range. Accordingly, even in case that the printed layer formed from the ink composition according to an embodiment is not provided as a multilayer but as a single layer, the printed layer may have excellent light-shielding properties, surface hardness, and durability and also have excellent adhesion strength to an adhesive layer. Therefore, the window including the single-layered printed layer formed from the ink composition of an embodiment may have improved durability and reliability.

Referring to FIG. 8C, the method of manufacturing a display device according to an embodiment may further include forming the window functional layer FC. The window WD according to an embodiment may be formed by disposing the window functional layer FC under the window base BS. The window functional layer FC may be formed on the second surface BS-UF of the window base BS, and may include at least one of an anti-fingerprint layer and a hard coating layer.

Referring to FIG. 8D, the providing of the display module (S300) may include providing the display module DM on the window WD. For example, the display module DM may be provided on a portion of the first surface BS-BF and the printed layer INL of the window base BS. The first adhesive layer AL-1 may be disposed between the display module DM and the window WD, so that the display module DM may be attached to the first surface BS-BF of the window base BS and the printed layer INL.

Referring to FIG. 8E, the providing of the set module (S400) may include providing the set module SM on the window WD and the display module DM. For example, the set module SM may be provided on a portion of the printed layer INL and house the display module DM. The second adhesive layer AL-2 may be disposed between the set module SM and the printed layer INL, so that the set module SM may be attached to the printed layer INL. The set module SM may be provided on the window WD and the display module DM, and thus the display device DD according to an embodiment may be formed.

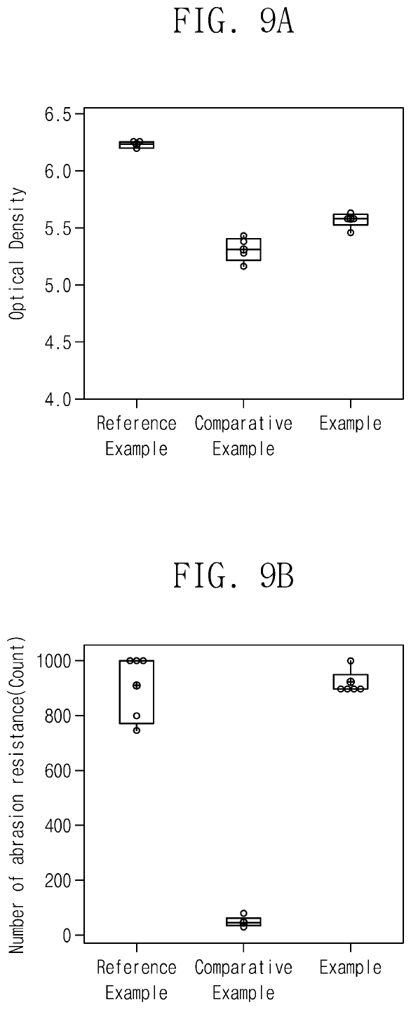

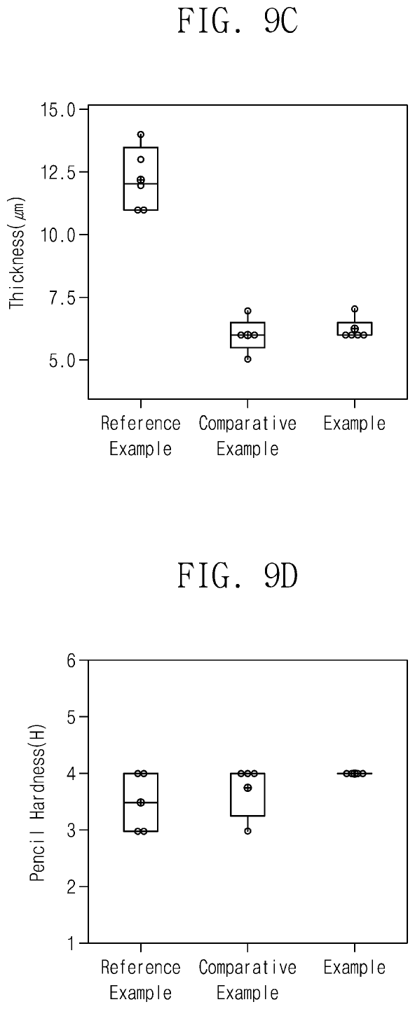

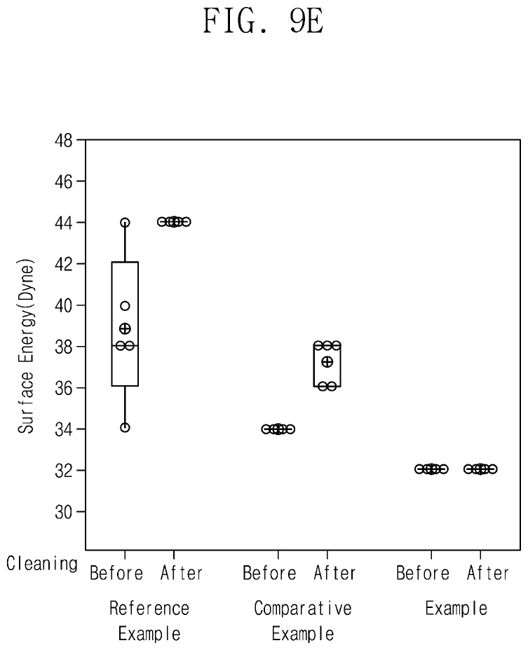

FIGS. 9A to 9E are graphs showing the evaluation results of the physical properties of a printed layer coating film formed from an ink composition according to an embodiment of the disclosure, and printed layer coating films formed from ink compositions according to Comparative Examples and Reference Examples. Hereinafter, a single-layered printed layer formed from an ink composition, according to an embodiment, will be described in detail with reference to the graphs shown in FIGS. 9A to 9E and to the evaluation results of Table 1. The examples shown below are merely provided for better understanding of the disclosure, and the scope of the disclosure is not limited thereto.

In FIGS. 9A to 9E, and Table 1, Examples is a printed layer coating film formed from an ink composition according to the embodiment. For example, the Example of a printed layer coating film according to the embodiment was prepared as a single layer from an ink composition formed by mixing a first ink composition which includes an acrylic resin in a range of about 40% to about 45% as a base resin, carbon black in a range of about 15% to about 20% as a pigment, and a matting agent, having a median particle size of about 1.5 μm, in an amount of about 3%, with a second ink composition which includes a tetra-functional blocked isocyanate in an amount of about 50%. In the ink composition, according to the embodiment, from which the printed layer coating film is formed, the mixing ratio of the first ink composition and the second ink composition may be about 100:30.

A printed layer coating film according to Reference Example may have a double-layered structure of a base ink layer and a shielding ink layer. In Reference Example, a base ink layer was prepared from an ink composition formed by mixing a first ink composition which includes an acrylic resin in a range of about 32% to about 37% as a base resin, carbon black in a range of about 15% to about 20% as a pigment, and does not include a matting agent, with a second ink composition including a tri-functional blocked isocyanate. In Reference Example, a shielding ink layer was prepared from an ink composition formed by mixing a first ink composition which includes an epoxy resin in a range of about 42% to about 47% as a base resin, carbon black in a range of about 10% to about 15% as a pigment, and a matting agent, having a median particle size of about 6 μm, in an amount of about 3%, with a second ink composition which includes an amine curing agent.

A printed layer coating film according to Comparative Example is a printed layer coating film which has a single-layered structure including only a shielding ink layer described above in Reference Example.

FIGS. 9A to 9E, and in Table 1, a film removal critical load is a value obtained by measuring the critical load at which the coating film is detached from the base substrate by using a Nano-Indenter. Chemical resistance is a number of times that alcohol-rubbing was performed with a load of 1 kg until defects such as stains occur on the printed layer coating film.

TABLE 1

| | | Reference | Comparative | |
|---|---|---|---|---|
| Categories | | Example | Example | Example |
| Thickness of Printing (μm) | | 12.2 | 6.0 | 6.2 |
| Optical density | | 6.22 | 5.31 | 5.56 |
| Pencil hardness (H) | | 3~4 | 3~4 | 4 |
| Film removal critical load (N) | | 2.25 | 1.16 | 1.68 |
| Chemical resistance (count) | | 910 | 48 | 920 |
| Surface energy | Before | 38 | 34 | 32 |
| after and before | After | 44 | 36 | 32 |
| cleaning (Dyne) | | | | |

Referring to the results of FIGS. 9A to 9E and Table 1, it may be confirmed that the printed layer coating film formed from the ink composition according to Example is provided as a single layer, and has a small thickness of about ½ compared to the thickness of the printed layer coating film according to Reference Example having a double-layered structure, and also has a higher optical density, pencil hardness, and a film removal critical load compared to the printed layer coating films according to Comparative Example having a single-layered structure. It may be confirmed that the printed layer coating film according to Example has higher chemical resistance to chemicals such as alcohol than the printed layer coating film according to Comparative Example, and has a less change in surface energy before and after cleaning compared to the printed layer coating films according to Reference Example and Comparative Example. Referring to Table 1 and the graphs of FIGS. 9A to 9E, it may be confirmed that the printed layer coating film formed from the ink composition according to the embodiment is provided as a single layer and has a small thickness while having excellent light-shielding properties, adhesion properties, and improved durability. Therefore, a window including the printed layer formed from the ink composition according to the embodiment may have a small thickness and improved durability and reliability, and also a display device including the window may have a small thickness while having improved durability and reliability.

A single-layered printed layer formed from an ink composition according to the embodiment may have improved light-shielding properties, surface hardness, durability, and adhesion strength. A window including a printed layer formed from the ink composition according to the embodiment and the display device including the same may have a small thickness while exhibiting improved durability.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments.

What is claimed is:

1. An ink composition comprising:
a base resin including an acrylic resin;
a multifunctional curing agent having four or more functional groups;
a pigment dispersed in the base resin; and
a matting agent having a median particle size in a range of about 1.0 μm to about 2.0 μm and dispersed in the base resin.

2. The ink composition of claim 1, wherein the ink composition includes:
a first ink composition comprising the base resin, the pigment, and the matting agent; and
a second ink composition comprising the multifunctional curing agent.

3. The ink composition of claim 2, wherein in case that a total content of the first ink composition is 100%, the first ink composition includes:
the base resin in a range of about 40% to about 45%;
the pigment in a range of about 15% to about 20%; and
the matting agent in a range of about 2% to about 4%.

4. The ink composition of claim 2, wherein
with respect to 100 parts by weight of the first ink composition, the second ink composition is included in a range of about 25 parts by weight to about 35 parts by weight, and
in case that a total content of the second ink composition is 100%, the second ink composition comprises the multifunctional curing agent in a range of about 45% to about 55%.

5. The ink composition of claim 2, wherein the first ink composition further comprises at least one of an antifoaming agent and a leveling agent.

6. The ink composition of claim 1, wherein the multifunctional curing agent comprises a tetra-functional blocked isocyanate.

7. The ink composition of claim 1, wherein a viscosity of the base resin is in a range of about 250 poise to about 350 poise.

8. The ink composition of claim 1, wherein
the base resin comprises a hydroxyl group,
the multifunctional curing agent comprises an isocyanate group, and
a ratio of the hydroxyl group to the isocyanate group in the ink composition is in a range of about 1:1.1 to about 1:1.5.

9. The ink composition of claim 1, wherein the base resin is a polymer resin having an average molecular weight in a range of about 20000 to about 40000.

10. A display device comprising:
a window;
a display module disposed on the window; and
a set module disposed on the display module, wherein
the window includes:
a window base; and
a printed layer disposed on a first side of the window base and formed from an ink composition,
the ink composition includes:
a base resin including an acrylic resin;
a multifunctional curing agent having four or more functional groups;
a pigment dispersed in the base resin; and
a matting agent having a median particle size in a range of about 1.0 μm to about 2.0 μm and dispersed in the base resin.

11. The display device of claim 10, further comprising:
an adhesive layer disposed between the window and the display module and/or between the window and the set module,
wherein the printed layer is attached to at least one of the display module and the set module by the adhesive layer.

12. The display device of claim 10, wherein the printed layer comprises:
a first printed layer including the matting agent and disposed adjacent to the display module and the set module; and
a second printed layer disposed between the first printed layer and the window base and not including the matting agent.

13. The display device of claim 10, wherein a thickness of the printed layer is in a range of about 5 μm to about 7 μm.

14. The display device of claim 10, wherein the printed layer is a single layer formed from the ink composition.

15. A method of manufacturing of a display device, comprising:
providing a window base having light-transmitting properties; and
forming a printed layer by providing an ink composition on the window base,
wherein the ink composition includes:
a base resin including an acrylic resin;
a multifunctional curing agent having four or more functional groups;
a pigment dispersed in the base resin; and
a matting agent having a median particle size in a range of about 1.0 μm to about 2.0 μm and dispersed in the base resin.

16. The method of claim 15, wherein the ink composition includes:
a first ink composition comprising the base resin, the pigment, and the matting agent; and
a second ink composition comprising the multifunctional curing agent.

17. The method of claim 16, wherein
with respect to 100 parts by weight of the first ink composition, the second ink composition is included in a range of about 25 parts by weight to about 35 parts by weight, and
in case that a total content of the second ink composition is 100%, the second ink composition comprises the multifunctional curing agent in a range of about 45% to about 55%.

18. The method of claim 15, wherein the printed layer is a single layer formed from the ink composition.

19. The method of claim 15, further comprising:
providing a display module on the window base,
wherein the display module is attached at least a portion of an upper surface of the window base and an upper surface of the printed layer by an adhesive layer.

20. The method of claim 15, further comprising:
providing a set module on the window base,
wherein the set module is attached to at least a portion of an upper surface of the printed layer by an adhesive layer.
